(19) United States
(12) Patent Application Publication
(10) Pub. No.: US 2016/0033621 A1
(43) Pub. Date: Feb. 4, 2016

(54) RADAR DEVICE, IN PARTICULAR FOR A MOTOR VEHICLE

(71) Applicant: HELLA KGAA HUECK & CO., Lippstadt (DE)

(72) Inventors: Thomas Ottenhues, Hörstel (DE); Henrik Sahlheiser, Soest (DE); Michael Schulte, Paderborn (DE); Dietmar Stapel, Sendenhorst (DE); Thomas Wixforth, Gütersloh (DE)

(21) Appl. No.: 14/772,204

(22) PCT Filed: Apr. 3, 2014
(86) PCT No.: PCT/EP2014/056679

§ 371 Date: Sep. 2, 2015

(30) Foreign Application Priority Data
Apr. 24, 2013 (DE) 10 2013 104 147.7

(51) Int. Cl. G01S 7/03

(52) U.S. Cl. CPC G01S 7/03; G01S 2007/027

(57) ABSTRACT

A radar device, in particular for a motor vehicle, which includes a housing having a first housing part that defines a receiving space (20) The housing also includes a second housing part, which is attached to the first housing part and forms a cover for at least the receiving space. Aa circuit board is accommodated within the housing, and the circuit board has at least one transmission antenna means for transmitting radar beams. The circuit board also has at least one receiving antenna means for receiving radar beams on a first surface which faces the second housing part when in the intended mounted position. The circuit board further includes electronic high frequency circuitry components and low frequency circuitry components on a second surface, as well as at least one shielding means inside the housing. The shielding means is configured for shielding against electromagnetic radiation. The shielding means comprises an integral shielding body disposed between the first housing part and the second housing part, and which is designed such that it can enclose the electronic high frequency circuitry components and the low frequency circuitry components.

### CROSS REFERENCE

This application claims priority to PCT Application No. PCT/EP2014/056679 filed Apr. 3, 2014, which itself claims priority to German Application No. 10 2013 104147.7, filed Apr. 24, 2013, the entirety of both of which are hereby incorporated by reference.

### FIELD OF TECHNOLOGY

The present invention relates to a radar device, in particular for a motor vehicle, comprising a housing having a first housing part, which defines a receiving space, and having a second housing part, which is attached to the first housing part and forms a cover for at least the receiving space, a circuit board, accommodated in the housing, wherein the circuit board has, on a first surface, which faces toward the second housing part when in the intended mounted position, at least one transmission antenna means for transmitting radar beams and at least one receiving antenna means for receiving radar beams, and has electronic high frequency circuitry components and low frequency circuitry components on a second surface, as well as at least one shielding means inside the housing, wherein the shielding means is configured for shielding against electromagnetic radiation.

### BACKGROUND

Radar devices for motor vehicles of the type specified above, having a housing in which at least one transmission antenna means for transmitting radar beams and at least one receiving antenna means for receiving radar beams are accommodated, are known from the prior art in various embodiments. Radar devices of this type are incorporated in a motor vehicle, for example, for determining a distance of a motor vehicle to a vehicle in front of it, and can be, in particular, a part of an automatic distance regulating device.

The first housing part of the radar device known from the prior art, forming a receiving space for the circuit board, is frequently made of die cast aluminum, and as a result is comparatively heavy and is furthermore expensive to manufacture. The radar devices already known from the prior art, the housings of which are made of plastic, have at least two circuit boards and more metal parts, provided as shielding means for shielding against electromagnetic radiation, wherein these metal parts may be made, in particular, of die case aluminum and/or sheet metal. Due to the numerous components that are to be incorporated in these radar devices, the costs for parts and labor are increased.

### SUMMARY OF THE INVENTION

The object of the present invention is to make available a radar device of the type specified in the introduction, which is light in weight and can be manufactured easily and inexpensively.

The radar device according to the invention is distinguished in that the shielding means comprises a single, integral shielding body, which is disposed between the first housing part and the second housing part, and is designed such that it can enclose the electronic high frequency circuitry components and the low frequency circuitry components. As a result of the housing being made entirely of plastic, the weight of the radar device can be significantly reduced in comparison with the radar devices known from the prior art, in which a housing part is made of a metallic substance—typically by more than one third, wherein an effective electromagnetic shielding is made available through the provision of the shielding body, in order to minimize electromagnetic interferences. Because the shielding body is an integral component, and thus can be easily installed, parts and labor costs can furthermore be reduced advantageously in comparison with the radar devices known from the prior art. In order to further simplify the installation, the radar device can advantageously comprise a single circuit board, on the second surface of which the electronic high frequency circuitry components and the electronic low frequency circuitry components are disposed.

It is proposed in a preferred embodiment that the shielding body be connected to the first housing part in a force-locking manner, in particular by means of at least one fastening screw, preferably by means of a number of fastening screws, or in a form-fitting manner, in particular by means of heat sealing. As a result, a secure retention of the shielding body on the first housing part is obtained. Through the use of at least one fastening screw, furthermore, an electrical connection (ground) between the shielding body and the circuit board can also be made available in an advantageous manner

In a preferred embodiment, it may be provided that the shielding body is made of metal, in particular die cast aluminum. A shielding body of this type is distinguished in particular by its stability and robustness. Due to the additional mechanical stability provided by the shielding body, the two housing parts made of plastic can be designed with lower mechanical stability. Weight and cost advantages are obtained thereby, through reduced material use.

In an alternative preferred embodiment, there is the possibility that the shielding body be made of plastic, and has, at least in sections, a metal coating and/or electrically conductive, in particular metal, particles embedded therein. As a result, it is advantageously possible to reduce the weight of the shielding body in comparison with a shielding body made entirely of metal, such that the overall weight of the radar device can be reduced.

In yet a further preferred embodiment, distinguished by a particularly low weight of the radar device, those regions of the first housing part that border on the receiving space can exhibit a coating, wherein the coating is electrically conductive (in particular, it contains metal) and forms the shielding means for shielding against electromagnetic radiation. This embodiment makes it possible to create a radar device that does not have an additional shielding body, and is thus particularly light. The coating can be a zinc coating (preferably having a thickness of approx. 80 μm). The coating can also be composed of a copper coating (preferably having a thickness of approx. 20 μm) and a nickel/chrome layer (preferably having a thickness of approx. 150 nm), for example.

In a particularly preferred embodiment, it is proposed that the second surface of the circuit board comprise a first surface section, in which, substantially, only the electronic high frequency circuitry components are disposed, as well as a second surface section, in which, substantially, only the electronic low frequency circuitry components are disposed. As a result, a spatial separation of the electronic high frequency circuitry components from the electronic low frequency circuitry components can be obtained on the circuit board in an advantageous manner.

In a particularly advantageous embodiment, it may be provided that the shielding body or the first housing part comprises a first shielding chamber, which is sized and shaped such that it can enclose the electronic high frequency circuitry components disposed in the first surface section, and at least a second shielding chamber, which is sized and shaped such that it can enclose the electronic low frequency circuitry components disposed in the second surface section.

In order to further reduce the danger of electromagnetic disturbances to the electronic high frequency circuitry components, there is the possibility, in a particularly advantageous embodiment, that a radar beam absorption body be disposed inside the first shielding chamber, preferably designed as a foam body. Preferably, the radar beam absorption body can be secured in the first shielding chamber by means of an adhesive.

In order to be able to design the radar device that is not provided with a separate shielding body such that it, particularly advantageously, has no screws, it is proposed in a particularly advantageous embodiment, that the circuit board be welded to a first housing part, or be glued thereto, preferably with an electrically conductive adhesive.

In a further advantageous embodiment, there is the possibility that at least one of the two housing parts comprises a plug-in means, which is formed as an integral part of the housing part.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows an exploded view of a radar device according to one preferred exemplary embodiment of the present invention.

FIG. 2 shows a perspective view of the radar device.

FIG. 3 shows a perspective view of the radar device with the housing cut partially away.

### DETAILED DESCRIPTION OF THE DRAWINGS

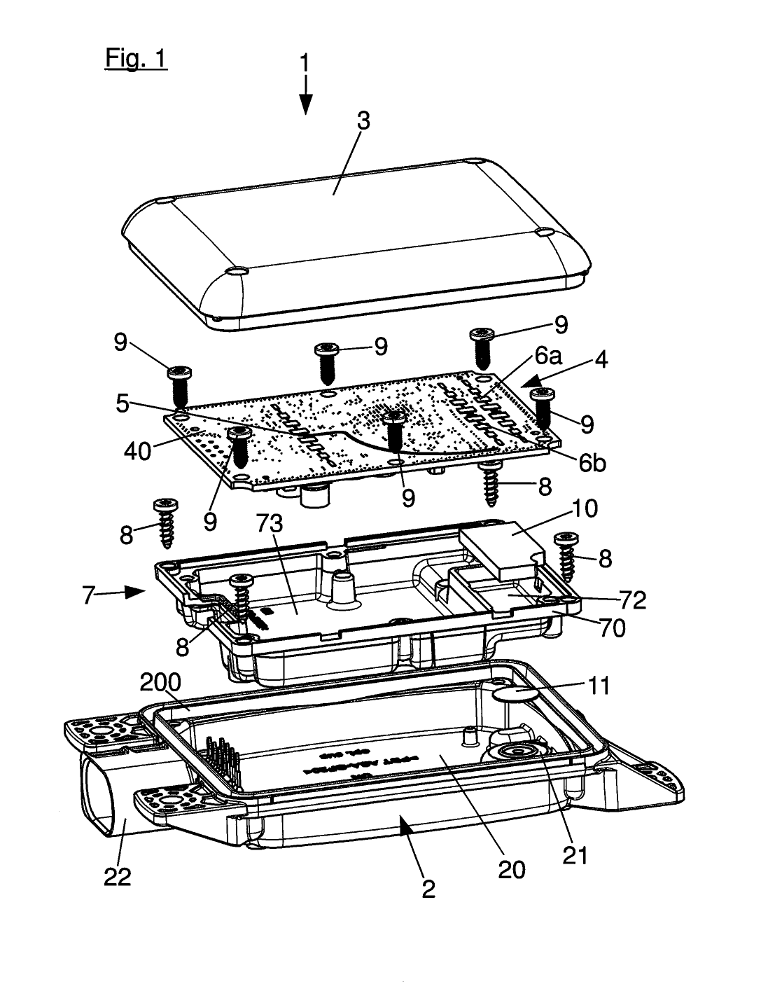

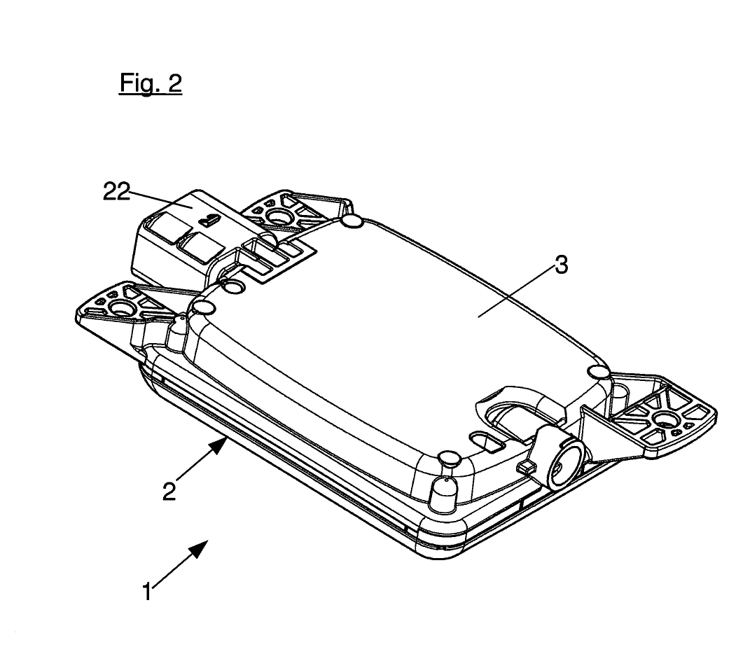

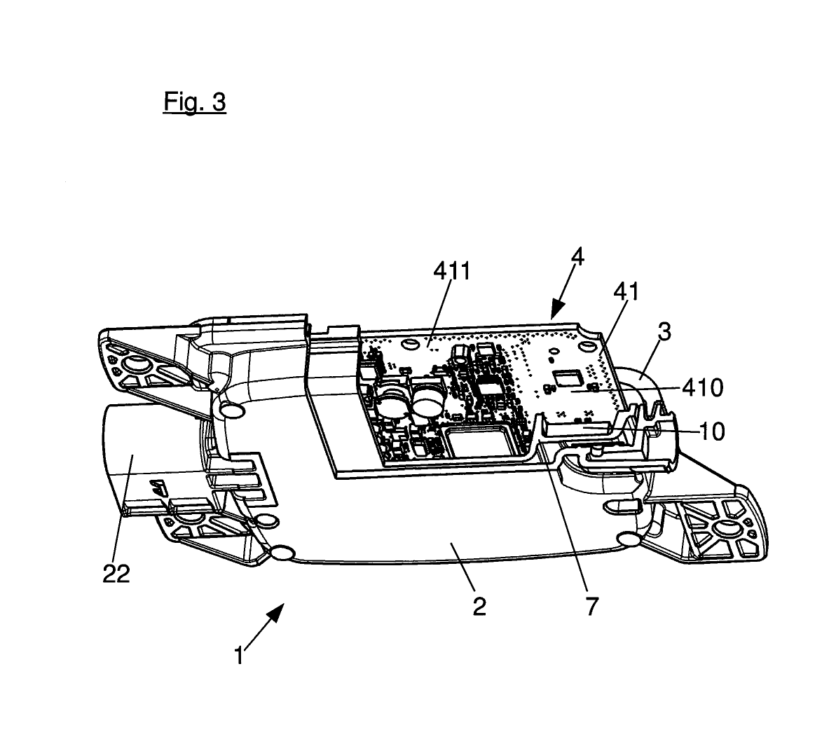

With reference to FIGS. 1 to 3, a radar device 1, which is designed according to one of the preferred embodiments of the present invention, comprises a housing having a first housing part 2 and a second housing part 3, both of which are made of a plastic material. The first housing part 2 has a receiving space 20, inside which a circuit board 4 as well as a shielding body 7, which extends between the first housing part 2 and the second housing part 3, and is designed such that it can shield against electromagnetic radiation, are accommodated. The second housing part 3 forms a cover (radome) for at least the receiving space 20 of the first housing part 2.

The circuit board 4 has a first surface 40, which faces the second housing part 3 when in the intended mounted position, a transmission antenna means 5, as well as two receiving antenna means 6a, 6b, which are configured for transmitting or receiving radar beams. The radar beams emitted by the transmission antenna means 5 during the operation of the radar device 1 are transmitted through the second housing part 3. Likewise, the radar beams reflected by an object and at least partially striking the radar device 1 are transmitted through the second housing part 3, and can be received by the receiving antenna means 6a, 6b.

Furthermore, the circuit board 4 comprises a second surface 41 lying opposite the first surface 40, a first surface section 410, in which, substantially, only electronic high frequency circuitry components are disposed, as well as a second surface section 411, in which, substantially, only electronic low frequency circuitry components are disposed. As a result, an effective spatial separation is obtained on the circuit board 4 between the high frequency circuitry components and the low frequency circuitry components.

The shielding body 7 is made as a single piece made of metal—preferably die cast aluminum—in this exemplary embodiment, and is formed such that it can be inserted precisely into the receiving space 20 of the first housing part 2 during the assembly, and with an upper edge section 70, extending at least in sections in the circumferential direction, lying at least in sections on the inside on an upper edge section 200 of the first housing part 2 extending in the circumferential direction. As a result, a non-slipping positioning of the shielding body 7 in the receiving space 20 of the first housing part can be obtained. The first housing part 2 comprises a connecting plug-in means 22 formed thereon in an integral manner in the exemplary embodiment shown here.

In an alternative embodiment, the shielding body 7 can also be made of plastic, and comprise an outer metal coating and/or electrically conductive (in particular metal) particles embedded in the plastic material. As a result, it is possible, in an advantageous manner, to reduce the weight of the shielding body 7 in comparison with a shielding body 7 made entirely of metal.

Because the shielding body 7 is disposed as a mechanical component in the interior of the housing between the first housing part 2 and the second housing part 3, the mechanical stability of the housing can be effectively increased in an advantageous manner, which can be further increased by a mechanical connection of the shielding body 7 to the first housing part 2. Due to the additional mechanical stability, made available by the shielding body 7, the two housing parts 2, 3 made of plastic can be designed with lower mechanical stability in an advantageous manner. Furthermore, weight and cost advantages are obtained with a lower use of materials.

The shielding body 7 is screwed to the first housing part 2 with four fastening screws 8 in the present example. Other force-locking types of connections, for the connection of the shielding body 7 to the first housing part 2, are fundamentally possible. Furthermore, there is the possibility of a form-fitting connection of the shielding body 7 to the first housing part 2, which can be obtained, in particular, through heat sealing. The fastening of the circuit board 4 to the shielding body 7 preferably occurs with screw fasteners. Six fastening screws 9 are provided for this in the present case, which are inserted through corresponding holes, not provided with reference symbols, in the circuit board 4 during the assembly, and engage thereby in corresponding threaded receivers in the shielding body 7. An electric connection (ground connection) is likewise established between the circuit board 4 and the shielding body 7 by means of these screw connections. In general, at least one fastening screw 9 may be provided for the connection of the circuit board 4 to the shielding body 7, which furthermore establishes the electrical connection (ground connection) explained above. Instead of a screw connection, having at least one fastening screw 9, the circuit board 4 can also be glued to the shielding body 7, wherein preferably an electrically conductive adhesive is used for establishing the adhesive connection, in order to obtain an electrical connection (ground connection) thereby.

The shielding body 7 is shaped such that it can enclose the electronic high frequency circuitry components and the electronic low frequency circuitry components disposed on the second surface 41 of the circuit board 4, in order to effectively shield these electronic circuitry components against the effects of electromagnetic radiation. In order to be able to separately shield the high frequency circuitry components and low frequency circuitry components, disposed on the circuit board 4 in the first or second surface section 410, 411, spatially separated from one another, the shielding body 7 comprises a first shielding chamber 72, sized and shaped such that it can enclose the electronic high frequency circuitry components disposed in the first surface section 410, and (at least) one second shielding chamber 73, sized and shaped such that it can enclose the electronic low frequency circuitry components disposed in the second surface section 411. In order to shield against the radar beams in the first shielding chamber 72, provided for the high frequency circuitry components, a radar beam absorption body 10, preferably designed as a foam body, is provided. The radar beam absorption body 10 is inserted in the first shielding body 72 during assembly, and secured therein, preferably by an adhesive connection.

The two housing parts 2, 3 of the radar device 1 can be connected to one another in a force-locking manner, using appropriate screw connections for example, or in a form-fitting manner, by means of a heat sealing for example. Alternatively, it is also possible to connect the two housing parts 2, 3 to one another in a material bonding manner, by means of an adhesive connection or a welding connection. In order to obtain pressure equalization in the interior of the housing in different environmental conditions, the radar device 1 has at least one pressure equalization means. The pressure equalization means is a pressure equalization diaphragm 11 in the present case, which is attached to a rise 21 in the floor of the receiving space 20 in the first housing part 2 (in particular by means of ultrasound welding).

In an alternative, second exemplary embodiment, not depicted explicitly herein, which enables a particularly high weight reduction, the radar device 1 can also be designed without the shielding body 7 described above. In order to be able to shield against electromagnetic radiation with this variation, those regions of the first housing part 2 bordering on the receiving space 20 are provided with an electrically conductive coating, preferably containing metal. The coating can, for example, be a zinc coating (preferably having a thickness of approx. 80 μm). The coating can, for example, also be composed of a copper layer (preferably having a thickness of approx. 20 μm) and a nickel/chrome coating (preferably having a thickness of approx. 150 nm). Thus, in this exemplary embodiment, the shielding body 7 and the fastening screws 8 provided for the attachment thereof to the first housing part 2 can be eliminated. The circuit board 4 is screwed in this exemplary embodiment to the first housing part 2 with at least one fastening screw (preferably a number of fastening screws, in particular six fastening screws). The connection of the two housing parts 2, 3 to one another can be obtained in the manner described above, in a force-locking manner, via appropriate screw connections, or in a form-fitting manner, by means of a heat sealing, for example. Alternatively, it is also possible to connect the two housing parts 2, 3 to one another, for example, by means of an adhesive connection, or by means of a welding connection.

In a third exemplary embodiment, which is likewise not depicted explicitly herein, the radar device 1 can be designed such that it contains no screws. In this case, the circuit board 4 is connected in a material-bonded manner to the first housing part 2, coated in the manner described above. This material-bonded connection can be obtained, for example, by welding or gluing, wherein for gluing, preferably an electrically conductive adhesive is used in order to establish an electrical connection (ground connection) between the circuit board 4 and the first housing part 2, provided with the electrically conductive coating.

### LIST OF REFERENCE SYMBOLS

1 radar device
2 first housing part
3 second housing part
4 circuit board
5 transmission antenna means
6a receiving antenna means
6b receiving antenna means
7 shielding body
8 fastening screw
9 fastening screw
10 radar beam absorption body
11 pressure equalization diaphragm
20 receiving space
21 rise
22 connection plug-in means
40 first surface
41 second surface
70 edge section
72 first shielding chamber
73 second shielding chamber
410 first surface section
411 second surface section
200 edge section

1. A radar device comprising:
a housing having a first housing part which defines a receiving space, said housing also having a second housing part which is attached to the first housing part and forms a cover for at least the receiving space;
a circuit board accommodated within the housing, said circuit board having:
at least one transmission antenna for transmitting radar beams;
at least one receiving antenna for receiving radar beams on a first surface which faces the second housing part when in the intended mounted position; and
electronic high frequency circuitry components and low frequency circuitry components on a second surface;
at least one shielding means inside the housing, wherein the shielding means is configured for shielding against electromagnetic radiation; and
wherein the shielding means comprises an integral shielding body disposed between the first housing part and the second housing part which is designed such that it can enclose the electronic high frequency circuitry components and the low frequency circuitry components.

2. The radar device according to claim 1, wherein the shielding body is connected to the first housing part in a force-locking manner, in particular by means of at least one fastening screw, or in a form-fitting manner, in particular by means of heat sealing.

3. The radar device according to claim 1, wherein the shielding body is made of metal, in particular die cast aluminum.

4. The radar device according to claim 1, wherein the shielding body is made of plastic, and at least in sections has a metal coating and/or electrically conductive metal particles embedded therein.

5. The radar device according to claim 1, wherein those regions of the first housing part bordering on the receiving space have a coating, wherein the coating is electrically conductive and forms the shielding means for the shielding against electromagnetic radiation.

6. The radar device according to claim 1 wherein the second surface of the circuit board comprises a first surface section in which, substantially, only the electronic high frequency circuitry components are disposed, as well as comprising a second surface section in which, substantially, only the electronic low frequency circuitry components are disposed.

7. The radar device according to claim 6, wherein the shielding body or the first housing part comprises a first shielding chamber sized and shaped such that it can enclose the electronic high frequency circuitry components disposed in the first surface section, and comprises at least one second shielding chamber sized and shaped such that it can enclose the electronic low frequency circuitry components disposed in the second surface section.

8. The radar device according to claim 7, wherein a radar beam absorption body is a foam body and is disposed inside the first shielding chamber.

9. The radar device according to claim 5, the circuit board is welded to the first housing part, glued thereto with an electrically conductive adhesive.

10. The radar device according to claim 1, wherein at least one of the two housing parts comprises a plug-in means which is formed on the housing part as an integral part thereof.
